(19) United States
(12) Patent Application Publication
(10) Pub. No.: US 2021/0354095 A1
(43) Pub. Date: Nov. 18, 2021

(54) IRRIGATION DEVICE

(71) Applicant: Luke Baldacchino, Tampa, FL (US)

(72) Inventor: Luke Baldacchino, Tampa, FL (US)

(21) Appl. No.: 17/317,341

(22) Filed: May 11, 2021

Related U.S. Application Data
(60) Provisional application No. 63/023,964, filed on May 13, 2020.

(51) Int. Cl. B01F 1/00; B01F 15/02; B01F 15/00

(52) U.S. Cl. CPC B01F 1/0033; B01F 15/026; B01F 2215/008; B01F 2001/0083; B01F 2015/00084; B01F 15/00415

(57) ABSTRACT

The present disclosure is directed to an apparatus for facilitating the delivery of one or more chemical compounds to a stream of a fluid

### BACKGROUND OF THE DISCLOSURE

In-ground lawn and garden irrigation systems are relatively common throughout the world for providing water to landscape features. Typical in-ground irrigation systems comprise a water source, underground piping to bring the water to various locations or stations about the lawn or garden, and sprinkler heads to direct the water onto the lawn or garden.

Permanently installed lawn and landscape irrigation systems have become very popular in recent years. Common lawn and landscape irrigation systems include a network of underground PVC tubing which supplies irrigating water to sprinkler heads spaced out throughout the area of lawn to be watered. Although these permanent sprinkler head irrigation systems are much more convenient than manually positioning sprinkler heads, there are a number of problems associated with permanent sprinkler head type irrigation systems.

The most important problem with sprinkler head irrigation systems is that such systems make very inefficient use of irrigation water. Sprinkler head systems deliver water to an area too fast for the surface to absorb and thereby waste irrigation water through runoff. Also, complete coverage of an area requires that the sprinkler heads be spaced such that their coverage areas overlap, as much as sixty percent overlap is common. This coverage overlap exacerbates the runoff problem. Also, the spray created by the sprinkler heads increases evaporation loss and in windy conditions is often blown outside of the area to be watered and into streets and parking areas, for example.

### BRIEF DESCRIPTION OF THE FIGURES

For a general understanding of the features of the disclosure, reference is made to the drawings. In the drawings, like reference numerals have been used throughout to identify identical elements.

FIG. 1 provides a cross-sectional view of an irrigation apparatus in accordance with one embodiment of the present disclosure.

FIG. 2 provides a side view of an irrigation apparatus in accordance with one embodiment of the present disclosure.

FIG. 3 provides a cross-sectional view of an irrigation apparatus in accordance with one embodiment of the present disclosure.

FIG. 4 provides a cross-sectional view of an irrigation apparatus in accordance with one embodiment of the present disclosure.

FIG. 5 provides a cross-sectional view of an irrigation apparatus in accordance with one embodiment of the present disclosure.

FIG. 6 provides a cross-sectional view of an irrigation apparatus in accordance with one embodiment of the present disclosure.

FIG. 7 provides a cross-sectional view of an irrigation apparatus in accordance with one embodiment of the present disclosure.

FIG. 8 provides a cross-sectional view of a canister element for use in conjunction with an irrigation apparatus in accordance with one embodiment of the present disclosure.

FIG. 9 provides a top-down view of an irrigation apparatus in accordance with one embodiment of the present disclosure.

FIG. 10 provides a cross-sectional view of a lid for use in conjunction with an irrigation apparatus in accordance with one embodiment of the present disclosure, wherein the lid includes at least one baffle for increasing the turbidity of a fluid flow through the irrigation apparatus.

FIG. 11 provides a cross-sectional view of an irrigation apparatus in accordance with one embodiment of the present disclosure.

FIG. 12 provides a side view of an irrigation apparatus in accordance with one embodiment of the present disclosure.

FIG. 13 provides a top-down view of an irrigation apparatus in accordance with one embodiment of the present disclosure.

### DETAILED DESCRIPTION

It should also be understood that, unless clearly indicated to the contrary, in any methods claimed herein that include more than one step or act, the order of the steps or acts of the method is not necessarily limited to the order in which the steps or acts of the method are recited.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the singular terms “a,” “an,” and “the” include plural referents unless context clearly indicates otherwise. Similarly, the word “or” is intended to include “and” unless the context clearly indicates otherwise. The term “includes” is defined inclusively, such that “includes A or B” means including A, B, or A and B.

As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (e.g. “one or the other but not both”) when preceded by terms of exclusivity, such as “either,” “one of” “only one of” or “exactly one of ” “Consisting essentially of,” when used in the claims, shall have its ordinary meaning as used in the field of patent law.

The terms “comprising,” “including,” “having,” and the like are used interchangeably and have the same meaning. Similarly, “comprises,” “includes,” “has,” and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b, and c. Similarly, the phrase: “a method involving steps a, b, and c” means that the method includes at least steps a, b, and c. Moreover, while the steps and processes may be outlined herein in a particular order, the skilled artisan will recognize that the ordering steps and processes may vary.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The present disclosure is directed to an apparatus for facilitating the delivery of one or more chemical compounds to a stream of a fluid (e.g. water). In general, the apparatus of the present disclosure is directed to one or more interconnected conduits for transferring a fluid (e.g. water) to a chamber where the fluid, once present within the chamber, may mix with one or more chemical compounds present within the chamber, such that the introduced fluid becomes enriched with the one or more chemical compounds. In some embodiments, the one or more chemical compounds are in solid form, e.g. tablets, powders, granules, or any combinations thereof. The enriched fluid is then transferred to an outlet where it may be dispersed. The apparatus may be part of a system which comprises one or more timers, sensors, pumps, control modules, baffles, bypasses, and/or valves as described herein.

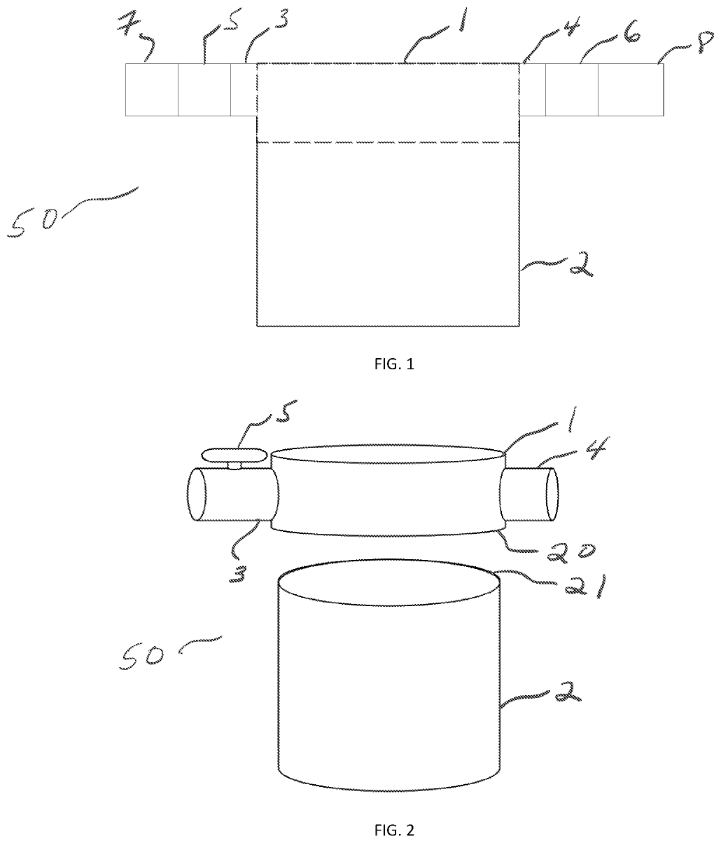

FIG. 1 depicts a non-limiting embodiment of an apparatus 50 of the present disclosure comprising a lid 1, a canister 2, a first fluid delivery member 3, and a second fluid delivery member 4. In some embodiments, the lid 1, cannister 2, and the first and second fluid delivery members 3 and 4 are in fluidic communication with each other. For example, fluid may flow in through the first delivery member 3, into the lid 1 and/or cannister 2, and out through the second fluid delivery member 4. FIG. 1 depicts the lid 1 and cannister 2 elements in a sealing engagement with each other (e.g. a fluid tight seal); while FIG. 2 depicts the lid 1 and cannister 2 elements disengaged from one another (e.g. in a configuration where one or more chemical components may be introduced into a chamber of cannister 2). In some embodiments, the first and second fluid delivery members may include one or more seals and/or gaskets.

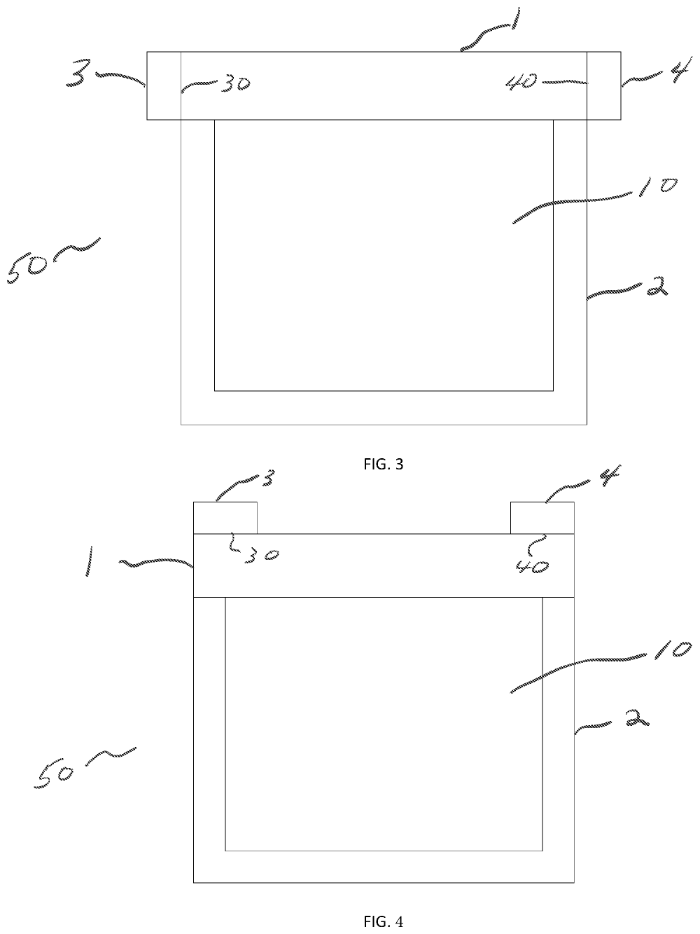

The fluid delivery members and may contain one or more valves. For example, the fluid delivery member may include a valve which regulates fluid flow through the fluid delivery member, to an inlet of the lid 30 (se FIG. 3). By “regulating fluid flow” it is meant that the flow of fluid through the fluid delivery member, and hence the volume of fluid passing through the fluid delivery member, may be reduced or completely stopped. In some embodiments, a valve is provided within a fluid delivery member to regulate fluid flow directly to the lid and/or cannister. In some embodiments, the one or more valves prevent backflow of the fluid out of the apparatus 50, such as backflow out of the cannister 2 or lid 1 and through the delivery member 3.

By way of example, the apparatus 50 may include one or more valves, 5 and 6, respectively, where the valves may be within a fluid flow path. In some embodiments, the valves 5 and 6 are manually controlled valves. In other embodiments, the valves 5 and 6 are electrically actuated. In some embodiments, the valves 5 and 6 are positioned proximal the first and second fluid delivery members 3 and 4, respectively. In some embodiments, one or more filters or mesh screens may be provided within the fluid flow path. In some embodiments, the mesh screen has a mesh size ranging from about 10 to about 270 US Mesh. In other embodiments, the mesh screen has a mesh size ranging from about 35 to about 270 US Mesh. In other embodiments, the mesh screen has a mesh size ranging from about 35 to about 230 US Mesh. In other embodiments, the mesh screen has a mesh size ranging from about 35 to about 200 US Mesh. In other embodiments, the mesh screen has a mesh size ranging from about 35 to about 170 US Mesh. In other embodiments, the mesh screen has a mesh size ranging from about 35 to about 140 US Mesh. In other embodiments, the mesh screen has a mesh size ranging from about 35 to about 120 US Mesh. In other embodiments, the mesh screen has a mesh size ranging from about 35 to about 100 US Mesh. In other embodiments, the mesh screen has a mesh size ranging from about 35 to about 80 US Mesh. In other embodiments, the mesh screen has a mesh size ranging from about 35 to about 70 US Mesh. In other embodiments, the mesh screen has a mesh size ranging from about 35 to about 60 US Mesh. In other embodiments, the mesh screen has a mesh size ranging from about 35 to about 50 US Mesh. In other embodiments, the mesh screen has a mesh size ranging from about 10 to about 50 US Mesh. In other embodiments, the mesh screen has a mesh size ranging from about 10 to about 40 US Mesh. In other embodiments, the mesh screen has a mesh size ranging from about 10 to about 35 US Mesh. In other embodiments, the mesh screen has a mesh size ranging from about 10 to about 30 US Mesh. In other embodiments, the mesh screen has a mesh size ranging from about 5 to about 50 US Mesh. In other embodiments, the mesh screen has a mesh size ranging from about 5 to about 25 US Mesh. In other embodiments, the mesh screen has a mesh size ranging from about 5 to about 15 US Mesh. In other embodiments, the mesh screen has a mesh size ranging from about 5 to about 10 US Mesh.

In some embodiments, a valve operated by a timer (e.g. manual or electronic) is inserted between the inlet 30 and the fluid source so as to reduce or stop fluid flow through the apparatus after a pre-determined amount of time has passed. In other embodiments, a valve may having a mass flow sensor or volume sensor is inserted between the inlet 30 and the fluid source so as to reduce or stop fluid flow through the apparatus after a pre-determined amount (e.g. by mass or by volume) of fluid is flowed through the apparatus or into the apparatus. It is believed that incorporation of such a valve and/or timer allows for the unsupervised use of the apparatus and/or prevents the unnecessary waste of aqueous fluid and/or chemical compounds. In some embodiments, timer may be set such that the valve closes after a predetermined period of operation. For example, the timer may command the valve to close after fluid flows through the apparatus for a time period ranging from between about 2 minutes to about 30 minutes. In some embodiments, the time period ranges from about 5 minutes to about 20 minutes. In some embodiments, the fluid valve may comprise a built-in timer. In some embodiments, a valve may actuated such that the aqueous fluid bypasses the cannister. In some embodiments, a timer may be operated such that water bypasses the cannister for a first predetermined amount of time; and such that water enters the cannister for a second predetermined amount of time,

The apparatus 50 of the present disclosure is connected to a fluid source. The apparatus may be directly connected to a source that provides for fluid flow. Alternatively, the apparatus may be connected to a pump or other means to actively deliver fluid to the apparatus 50. Of course, the skilled artisan will recognize that any number of different fluid sources and/or pumps may be utilized and regulated to provide the desired fluid flow rate and volume. In some embodiments, the fluid source, pump, and/or apparatus may comprise control logic, sensors, or meters which monitor the fluid flow rate and fluid flow volume through the apparatus 50 and/or system in which the apparatus 50 is integrated. In some embodiments, the fluid source and/or pump may deliver a pre-determined volume of fluid through the apparatus 50 and/or system. In some embodiments, the pre-determined volume of fluid ranges from between about 10 L to about 1000L. In other embodiments, the pre-determined volume of fluid ranges from between about 15 L to about 500L. In yet other embodiments, the pre-determined volume of fluid ranges from between about 25 L to about 100L. In even further embodiments, the pre-determined volume of fluid ranges from between about 25 L to about 50L.

In some embodiments, the apparatus 50 further includes an inlet manifold 7 and an outlet manifold 8. In some embodiments, the inlet manifold 7 facilitates the coupling of the apparatus 50 to a fluid source. Likewise, the outlet manifold 8 facilitate the coupling of the apparatus to a fluid outlet. In some embodiments, the inlet and outlet manifolds 7 and 8 facilitate the coupling (direct or indirect) of the apparatus 50 with one or more pumps. In some embodiments, the inlet and outlet manifolds 7 and 8, respectively, facilitate the coupling of the apparatus 50 to an existing system, e.g. an existing lawn sprinkler system. In some embodiments, the inlet and outlet manifolds may include one or more seals and/or gaskets.

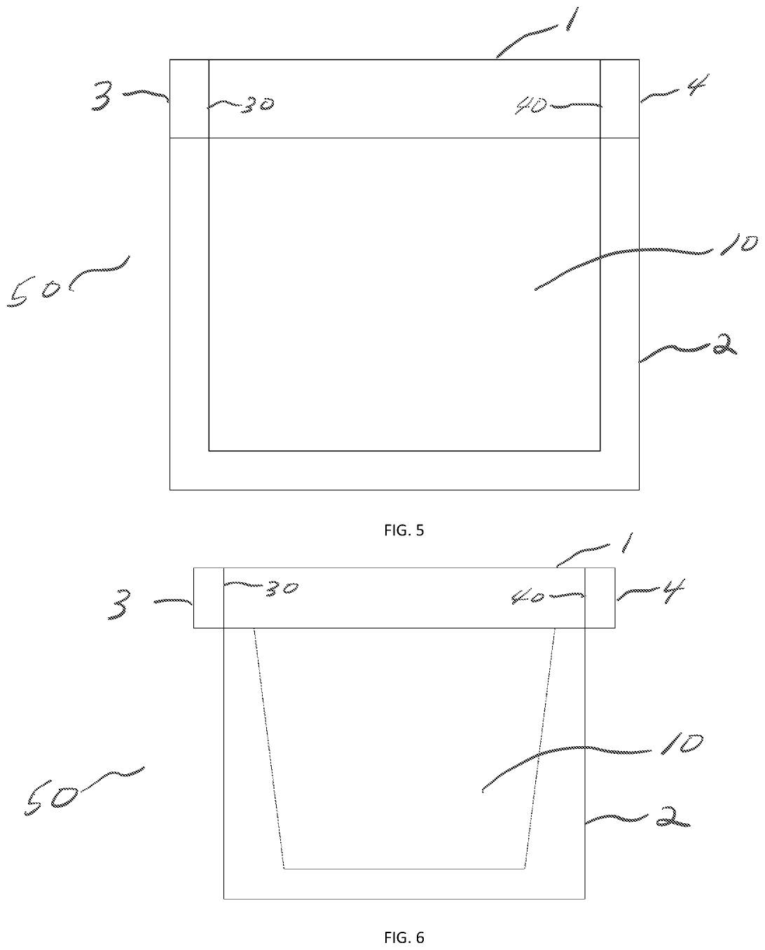

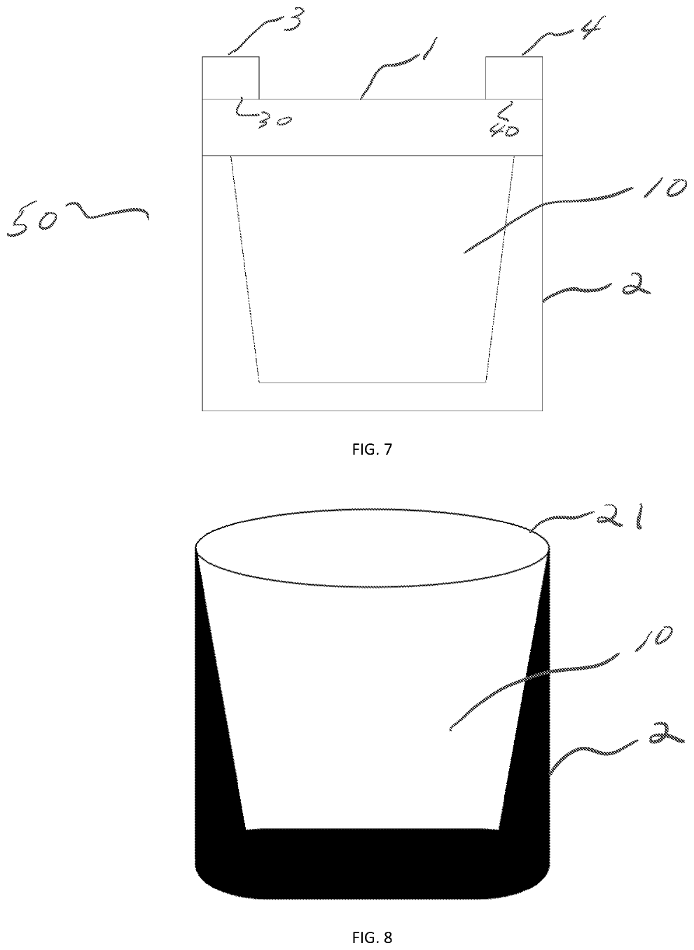

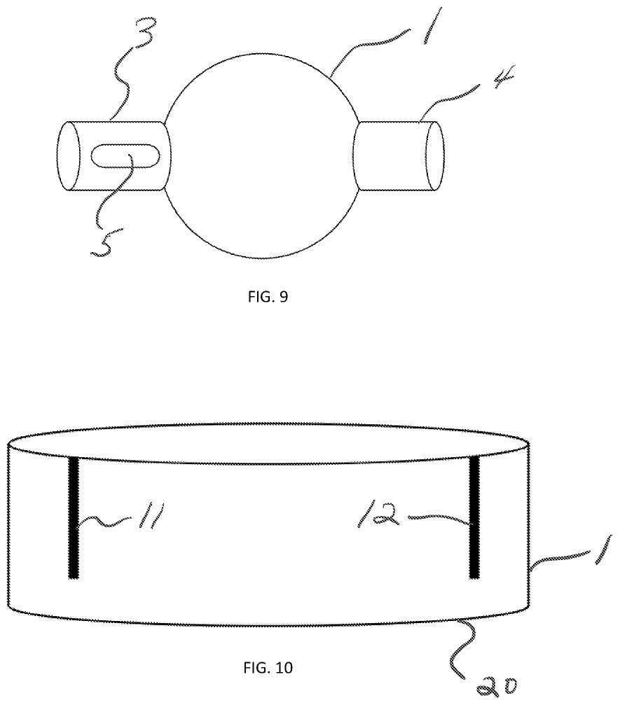

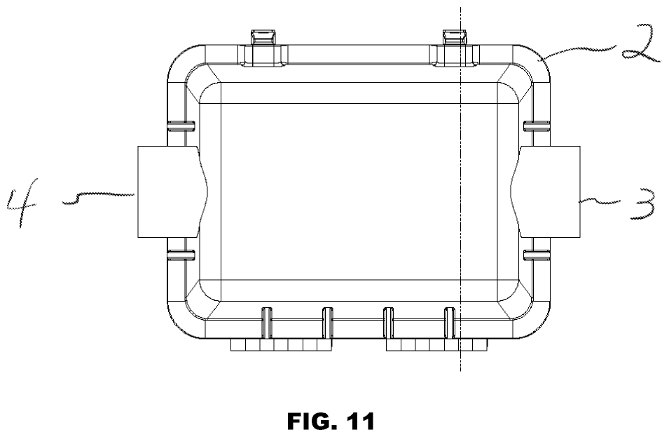

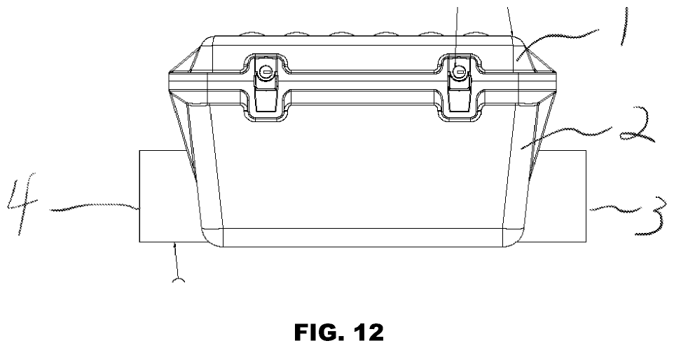

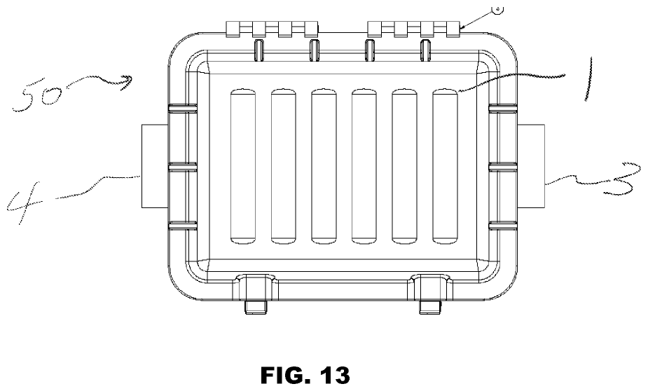

FIG. 3 illustrates a cross-section of apparatus 50 and showing an inlet 30 of lid 1 in fluidic communication with the first fluid delivery member 3. FIG. 3 further illustrates an outlet 40 of lid 1 in fluidic communication with the second fluid delivery member 4. The first and second fluid delivery members 3 and 4 and the inlets and outlets 30 and 40, respectively, may be coupled to the sides of the lid 1 or coupled through the top of the lid 1 (compare FIGS. 3 and 4). In some embodiments, the first and second fluid delivery members 3 and 4 may be external relative to the lid 1 (but fluidically coupled to the lid 1) or may be included within lid 1 itself (compare FIGS. 3 and 5).

The skilled artisan will appreciate that the lid may comprise one or more additional fluid delivery members such that the apparatus 50 may be coupled to more than one fluid source or where the fluid may be directed to more than one downstream system component. Likewise, the skilled artisan will recognize that the apparatus 50 of the present disclosure may comprise more than one inlet (e.g. so as to provide a mixture of different fluids from different sources), and any inlet may be provided at any part of the apparatus. Moreover, two or more of the apparatuses of the present disclosure may be fluidically coupled to each other, e.g. in a parallel or series arrangement. In some embodiments, the cannisters of each may include the same or different chemical compounds.

The lid 1 and canister element 2 may have any size and shape. In some embodiments, the lid 1 and canister 2 are both substantially circular. In other embodiments, the lid 1 and canister 2 are rectangular. In yet other embodiments, the lid 1 and canister 2 are square.

In some embodiments, the lid 1 comprises a circular lower surface 20 which engages a circular upper surface 21 of the cannister 2 such that the lid 1 and cannister 2 may form a fluid-tight seal. In some embodiments, the circular lower surface 20 and the circular upper surface 21 include features (e.g. tabs) or sets of features which are complementary to each other such that when the circular lower surface 20 and the circular upper surface 21 are brought into contact with one another, a fluid-tight seal may be formed between the lid 1 and the cannister 2. In some embodiments, circular upper surface 21 and the circular lower surface 20 may include threading, such that the lid 1 and canister 2 may be screwed together.

In some embodiments, circular lower surface 20 and the circular upper surface 21 are releaseably engaged with one another with one or more clamps or screws. For instance, the lid 1 may be screwed onto the cannister 2. In other embodiments, the lid 1 may be clamped onto the cannister 2.

In some embodiments, a seal body is disposed between the circular lower surface 20 and the circular upper surface 21. In some embodiments, the seal body is in the form of an O-ring seal. By an “O-ring seal” it is meant an annular seal, irrespective of the shape of its cross section. In some embodiments, a seal body may be inserted within a groove present within one or both of the circular lower surface 20 and/or the circular upper surface 21.

In some embodiments, a seal body may be comprised of a material that is resistant to chemicals and/or heat. In some embodiments, the seal body is comprised of a metal. In some embodiments, the seal body is compressible and/or temporarily deformable. In some embodiments, the seal body is comprised of a material such as rubber, silicon, or a fluorocarbon rubber. Suitable examples of rubber include, but are not limited to, ethylene propylene diene monomer (EPDM), ethylene propylene rubber, chloroprene rubber (CR), butyl rubber (IIR), and silicone rubber. Suitable examples of fluorocarbon rubbers include, but are not limited to, a vinylidene fluoride rubber of a binary system such as a vinylidene fluoride/hexafluoropropylene copolymer, a vinylidene fluoride/trifluorochloroethylene copolymer, and a vinylidene fluoride/pentafluoropropylene copolymer, a vinylidene fluoride rubber of a ternary system such as a vinylidene fluoride/tetrafluoroethylene/hexafluoropropylene copolymer, a vinylidene fluoride/tetrafluoroethylene/perfluoroalkylvinyl ether copolymer, and a vinylidene fluoride/tetrafluoroethylene/propylene copolymer, a tetrafluoroethylene/propylene copolymer, a tetrafluoroethylene/perfluoroalkylvinyl ether copolymer, and a thermoplastic fluorocarbon rubber.

In other embodiments, the seal body may be comprised of a perfluoroelastomer, such as those recited in U.S. Pat. No. 7,834,096, the disclosure of which is hereby incorporated by reference herein in its entirety. In yet other embodiments, the seal body may be comprised of nitriles, such as acrylonitrile-butadiene (NBR), hydrogenated nitrile (HNBR), and carboxylated nitrile (XNBR); fluorocarbon (FKM); fluorosilicone (FVMQ); perfluoroelastomer (FFKM); tetrafluoroethylene-propylene (FEPM); ethylene acrylate (AEM); polyacrylate; and thermoplastic polyurethane. In further embodiments, the seal may be comprised of a material that is heat-resistant, such as any of those described within U.S. Pat. No. 7,919,554, the disclosure of which is hereby incorporated by reference herein in its entirety.

The components of the apparatus of the present disclosure may be constructed of any material. In some embodiments, the components are constructed of materials that are resistant to the chemicals and/or fluids used in operation of the apparatus. In other embodiments, the components are constructed of rust-proof materials or materials which have been treated with rust-proof or rust-resistant coatings. In yet other embodiments, the components are constructed of polymers, polymer blends, copolymers, and co-polymer blends as known to those of ordinary skill in the art. In yet further embodiments, components are constructed from synthetic rubbers, phenol formaldehyde resins, nylons, polyvinyl chloride (PVC or vinyl), polystyrene, polyethylene, polypropylene, polyacrylonitrile, polyvinyl butyral (“PVB”), silicone, polyoxymethylene (“acetal”), acrylonitrile butadiene styrene (“ABS”), and any combination thereof.

In some embodiments, the lid 1 and the cannister 2 are formed by machining or milling a block of solid material. In other embodiments, the lid 1 and the cannister 2 are formed through a 3D printing process. In other embodiments, the lid 1 and the cannister 2 are produced from a mold. The lid 1 and the cannister 2 may be fabricated from any material. For example, the lid 1 and the cannister 2 (or any constituent part of either) may be made from a metal or an alloy; ceramic; glass; or plastic (e.g. derived from a polymer, a copolymer, or a polymer or co-polymer blend). Examples of suitable polymers include, but are not limited to, polyether ether ketone, polyimides, polyetherimide, polytetrafluoroethylene, polysulfones, polyvinylidene difluoride, and polyphenylene sulfide. Examples of suitable metal materials include aluminum and steel. In some embodiments, if the upper plate is made from a metal, the metal may be coated or uncoated (e.g. coated with a fluoropolymer).

In some embodiments, the lid 1 comprises one or more baffles, e.g. baffles 11 and 12. In some embodiments, the lid 1 comprises 1 baffle. In other embodiments, the lid comprises 2 baffles. In yet other embodiments, the lid comprises 3 or more baffles. In further embodiments, the lid comprises 4 or more baffles. In some embodiments, the one or more baffles are positioned in line with a fluid inlet and/or fluid out. In some embodiments, the one or more baffles are adapted to introduce turbidity into the fluid flow. In some embodiments, the one or more baffles 11 and 12 extend the full height of the lid 1. In other embodiments, the one or more baffles 11 and 12 extend less than the full height of the lid 1 (see FIG. 10).

The chamber 10 may have any size or shape. In some embodiments, the chamber 10 has a substantially conical shape. In other embodiments, the chamber 10 has a substantially rectangular shape.

In some embodiments, the chamber 10 may be configured to hold tablets in different forms; or tablets including different chemical compounds based on treatment objectives. In some embodiments, a plurality of tables including the one or more chemical compounds may be deposited within the chamber 10. In other embodiments, the chamber may include a removable basket for hold a plurality of tablets including the one or more chemical compounds. In some embodiments, the chamber 10 may be configured to hold a solitary tablet included the one or more chemical compounds.

The conduits and fluid delivery members may independently have any size and shape. For example, the conduits and fluid delivery members 40 may have a size ranging from between 0.75 inches (1.905 cm) and 6.5 inches (16.51 cm) in length. By way of further example, the conduits and fluid delivery members may have a diameter ranging from between 0.25 inches (0.635 cm) to about 1.5 inches (3.81 cm) and may vary depending on the application size or area. In some embodiments, some conduits and fluid delivery members may have a first size while other conduits and fluid delivery members may have a second size (length and/or conduit diameter). The conduits and fluid delivery members may have any interior shape or diameter to accommodate different volumes and/or flow rates of aqueous fluid. For example, a cross-section of any conduit and fluid delivery member may be circular, oval, square, etc. The skilled artisan will appreciate that given a constant flow rate at an inlet, the velocity of the aqueous fluid moving through the conduit may be altered based on the interior diameter of the conduits and fluid delivery members. In some embodiments, the conduits and fluid delivery members may have a variable interior diameter that changes as the distance from the inlet increases so as to maintain a constant flow of fluid (and/or pressure) throughout the apparatus.

In some embodiments, the apparatus 50 can be installed across any type of irrigation system and may come in various sizes depending on the application type. For example, a sports field may use 1″ diameter conduits and/or fluid delivery members (or even larger) and so the invention can be made larger to accommodate an increased water flow, or house a larger amounts of the chemical components (e.g. tablets) to ensure application concentration remains substantially the same despite a larger treatment area.

The apparatus 50 (or any of the components thereof) may be operated manually or may be automated. For example, the apparatus 50 may be connected to computer, programmable controller (e.g. a programmable logic controller, “PLC”), custom-built controllers, or other control modules or timers (herein “computer”) that facilitate the operation of apparatus 50. In addition, where the apparatus comprises one or more electronically controlled valves, the computer may be programmed to control the operation of those values, where each valve may be controlled independently. In other embodiments, a user may program the computer to provide for a certain pre-determined flow rate or quantity of water to flow through the entire apparatus or any individual fluid delivery member, delivery member, such as by regulating fluid flow at the inlet, at a pump fluidically coupled upstream or downstream from the apparatus 50, or any of the valves. The skilled artisan will recognize that the parameters for operation may be based on the fluid being introduced into the apparatus, the size of the conduits, canisters, etc. In some embodiments, the system allows for the remote monitoring and/or the remote control of the apparatus and any connected components (e.g. valves, timers, etc.).

In some embodiments, the one or more chemical compounds are water soluble wetting agents. In some embodiments, the one or more chemical compounds are water-soluble surfactants and the fluid is water. As used herein, “surfactants” are classified as anionic, cationic, or nonionic, depending on their mode of chemical action. In general, surfactants reduce interfacial tension between two liquids. A surfactant molecule typically has a polar or ionic “head” and a nonpolar hydrocarbon “tail.” Upon dissolution in water, the surfactant molecules aggregate and form micelles, in which the nonpolar tails are oriented inward, and the polar or ionic heads are oriented outward toward the aqueous environment. The nonpolar tails create a nonpolar “pocket” within the micelle. Nonpolar compounds in the solution are sequestered in the pockets formed by the surfactant molecules, thus allowing the nonpolar compounds to remain mixed within the aqueous solution. In some embodiments, the surfactant may be used to produce uniform spreading of reagents across a tissue section as well as decrease background staining. The surfactant may be one of an anionic surfactant, a cationic surfactant, a non-ionic surfactant, or mixtures thereof.

Anionic surfactants are generally based upon sulfates, sulfonates, phosphates, or carboxylates and contain a water-soluble cation. A representative formula of a sulfonate is R—SO3M where R is a hydrocarbon group of from about 5 to 22 carbon atoms which may be linked through an alkoxy or oxyalkoxy to the sulfonate functionality and M is a water-soluble cation such as an alkali metal. Anionic surfactants include alkyl ether sulfates, alkyl sulfates and sulfonates, alkyl carboxylates, alkyl phenyl ether sulfates, sodium salts of alkyl poly(oxyethylene) sulfonates, sodium salts of alkyl benzyl sulfonate, such as sodium salts of dodecylbenzyl sulfonate and sodium lauryl ether sulfate. Anionic surfactants also include anionic phosphate esters.

In some embodiments, the surfactants include, but are not limited to polyoxyethylene alkyl ether, wherein the alkyl is (CH₂)_{M} and the oxyethylene is (C₂H₄O)_{N}, wherein M is an integer from 5 to 16, from 8 to 14, or from 10 to 12 and N is an integer from 10 to 40, from 15 to 30, or from 20 to 28. In one embodiment, the surfactant is polyoxyethylene lauryl ether having a formula (C₂H₄O)₂₃C₁₂H₂₅OH. In another embodiment, the surfactant is a polyoxyethylene (20) sorbitan monoalkylate, the monoalkylate comprising between 8 and 14 carbons. In another embodiment, the surfactant is a linear secondary alcohol polyoxyethylene having a formula C₁₂₋₁₄H₂₅₋₂₉O(CH₂CH₂O]ₓ, wherein x equals an integer between 2 and 12. In yet another embodiment, the surfactant is a polyoxyethylene octyl phenyl ether. Exemplary surfactants are sold under the names: Brij® 35, TWEEN®, Tergitol™, Triton™, Ecosurf™, Dowfax™, polysorbate 80™, BigCHAP, Deoxy BigCHAP, IGEPAL®, Saponin, Thesit®, Nonidet®, Pluronic F-68, digitonin, deoxycholate, and the like. Particular disclosed working embodiments concern using surfactants selected from Brij® 35, TWEEN®, Tergitol™, Triton™.

Cationic surfactants useful in compositions of the present disclosure contain amino or quaternary ammonium moieties. Cationic surfactants among those useful herein are disclosed in the following documents: M.C. Publishing Co., McCutcheon's, Detergents & Emulsifiers, (North American edition 1979); Schwartz, et al.; Surface Active Agents, Their Chemistry and Technology, New York: Interscience Publishers, 1949; U.S. Pat. No. 3,155,591, Hilfer, issued Nov. 3, 1964; U.S. Pat. No. 3,929,678, Laughlin et al., issued Dec. 30, 1975; U.S. Pat. No. 3,959,461, Bailey et al., issued May 25, 1976; and U.S. Pat. No. 4,387,090, Bolich, Jr., issued Jun. 7, 1983.

Among the quaternary ammonium-containing cationic surfactant materials useful herein are those of the general formula:

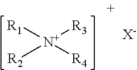

wherein R1-R4 are independently an aliphatic group of from about 1 to about 22 carbon atoms or an aromatic, alkoxy, polyoxyalkylene, alkylamido, hydroxyalkyl, aryl or alkylaryl group having from about 1 to about 22 carbon atoms; and X is a salt-forming anion such as those selected from halogen, (e.g. chloride, bromide), acetate, citrate, lactate, glycolate, phosphate nitrate, sulfate, and alkylsulfate radicals. The aliphatic groups may contain, in addition to carbon and hydrogen atoms, ether linkages, and other groups such as amino groups. The longer chain aliphatic groups, e.g., those of about 12 carbons, or higher, can be saturated or unsaturated. Especially preferred are mono-long chain (e.g., mono C₁₂ to C₂₂, preferably C₁₂ to C₁₈, more preferably C₁₆, aliphatic, preferably alkyl), di-short chain (e.g., C₁ to C₃ alkyl, preferably C₁ to C₂ alkyl) quaternary ammonium salts.

Salts of primary, secondary and tertiary fatty amines are also suitable cationic surfactant materials. The alkyl groups of such amines preferably have from about 12 to about 22 carbon atoms and may be substituted or unsubstituted. Such amines, useful herein, include stearamido propyl dimethyl amine, diethyl amino ethyl stearamide, dimethyl stearamine, dimethyl soyamine, soyamine, myristyl amine, tridecyl amine, ethyl stearylamine, N-tallowpropane diamine, ethoxylated (with 5 moles of ethylene oxide) stearylamine, dihydroxy ethyl stearylamine, and arachidylbehenylamine. Suitable amine salts include the halogen, acetate, phosphate, nitrate, citrate, lactate, and alkyl sulfate salts. Such salts include stearylamine hydrochloride, soyamine chloride, stearylamine formate, N-tallowpropane diamine dichloride, stearamidopropyl dimethylamine citrate, cetyl trimethyl ammonium chloride and dicetyl diammonium chloride. Preferred for use in the compositions herein are cetyl trimethyl ammonium chloride, stearyl trimethyl ammonium chloride, tetradecyltrimethly ammonium chloride, dicetyldimethyl ammonium chloride, dicocodimethyl ammonium chloride and mixtures thereof. More preferred is cetyl trimethyl ammonium chloride.

The compositions of the disclosure may also include various non-ionic surfactants. Among the suitable nonionic surfactants are condensation products of C₈-C₃₀ alcohols with sugar or starch polymers. These compounds can be represented by the formula (S)ₙ—O—R, wherein S is a sugar moiety such as glucose, fructose, mannose, and galactose; n is an integer of from about 1 to about 1000, and R is C₈-C₃₀ alkyl. Examples of suitable C₈-C₃₀ alcohols from which the R group may be derived include decyl alcohol, cetyl alcohol, stearyl alcohol, lauryl alcohol, myristyl alcohol, oleyl alcohol, and the like. Specific examples of these surfactants include decyl polyglucoside and lauryl polyglucoside.

Other suitable nonionic surfactants include the condensation products of alkylene oxides with fatty acids (i.e., alkylene oxide esters of fatty acids). These materials have the general formula RCO(X)ₙ OH, wherein R is a C₁₀-C₃₀ alkyl, X is —OCH₂CH₂— (derived from ethylene oxide) or —OCH₂CHCH₃— (derived from propylene oxide), and n is an integer from about 1 to about 200.

Yet other suitable nonionic surfactants are the condensation products of alkylene oxides with fatty acids (i.e., alkylene oxide diesters of fatty acids) having the formula RCO(X)₂OOCR, wherein R is a C₁₀-C₃₀ alkyl, X is —OCH₂CH₂— (derived from ethylene oxide) or —OCH₂CHCH₃—(derived from propylene oxide), and n is an integer from about 1 to about 200. Yet other nonionic surfactants are the condensation products of alkylene oxides with fatty alcohols (i.e., alkylene oxide ethers of fatty alcohols) having the general formula R(X)ₙOR′, wherein R is C₁₀-C₃₀ alkyl, n is an integer from about 1 to about 200, and R′ is H or a C₁₀-C₃₀ alkyl.

Still other nonionic surfactants are the compounds having the formula RCO(X)ₙOR′ wherein R and R′ are C₁₀-C₃₀ alkyl, X is —OCH₂CH₂— (derived from ethylene oxide) or OCH₂CHCH₃— (derived from propylene oxide), and n is an integer from about 1 to about 200. Examples of alkylene oxide-derived nonionic surfactants include ceteth-1, ceteth-2, ceteth-6, ceteth-10, ceteth-12, ceteraeth-2, ceteareth6, ceteareth-10, ceteareth-12, steareth-1, steareth-2, stearteth-6, steareth-10, steareth-12, PEG-2 stearate, PEG4 stearate, PEG6 stearate, PEG-10 stearate, PEG-12 stearate, PEG-20 glyceryl stearate, PEG-80 glyceryl tallowate, PPG-10 glyceryl stearate, PEG-30 glyceryl cocoate, PEG-80 glyceryl cocoate, PEG-200 glyceryl tallowate, PEG-8 dilaurate, PEG-10 distearate, and mixtures thereof. Still other useful nonionic surfactants include polyhydroxy fatty acid amides disclosed, for example, in U.S. Pat. Nos. 2,965,576, 2,703,798, and 1,985,424, which are incorporated herein by reference.

Exemplary surfactants include Tomadol 1200 (Air Products), Tomadol 900 (Air Products), Tomadol 91-8 (Air Products), Tomadol 1-9 (Air Products), Tergitol 15-S-9 (Sigma), Tergitol 15-S-12 (Sigma), Masud NRW-N (Pilot Chemical), Bio-Soft N91-6 (Stepan), and Brij-35 (Polyethylene glycol dodecyl ether) (Sigma).

Non-limiting examples of surfactants include Tomadol 1200 (Air Products), Tomadol 900 (Air Products), Tomadol 91-8 (Air Products), Tomadol 1-9 (Air Products), Tergitol 15-S-9 (Sigma), Tergitol 15-S-12 (Sigma), Masurf NRW-N (Pilot Chemical), Bio-Soft N91-6 (Stepan), and Brij-35 (Polyethylene glycol dodecyl ether) (Sigma).

In some embodiments, the surface is selected from Polyhydroxyethyl alkoxy alkylene oxides, Polyoxyethylene-polyoxyprolyene block co-polymers, Etherified polyoxyethylene-polyoxyprolyene block co-polymers, Modified alkylated polyols, Modified/Methyl capped block co-polymers, Non-Ionic polyols, Non-ionic surfactants, Alkoxylated polyols., Alkyl polyglycosides, Glucoethers, Alkoxylated alcohols, Alcohol ethoxylates, Polyoxytheylene, Anioinic blends, Ethylene oxides, Nonylphenol ethoxylates, Sodium laureth sulfates, Laureth sulfates, Ammonium laureth sulfates, TEA lauryl sulfate, Diethylhexyl sodium sulfosuccinate, Sodium lauroyl sarcosinates, Sodium stearate, Sodium olefin sulfonate, Disodium laureth sulfosuccinate, Disodium oleamine sulfosuccinate, Sodium dioctyl sulfosuccinate Sodium cocoyl isethionate, Sodium capryloyl isethionate, Sodium caproyl isethionate, Sodium lauroyl isethionate, Sodium palmitoyl isethionate, Acrylates/Steareth-20 itaconate copolymer, Ammonium capryleth sulfate, Ammonium pareth-25 sulfate, Ammonium myreth sulfate, Ceteareth-20, Cocamidopropyl betaines, Disteareth-75 IPDI, -100 IPDI, Emulsifying wax NF, Isosteareth-20, Steareth-2, -4, 10, 16, -20, 21, Isosteareth-2, -10, -20, Magnesium laureth sulfate, Magnesium oleth sulfate, Polyethylene glycols, PEG-20, PEG-40, Phenoxyethanol, olyoxyethylene, Polysorbate-20, -40, -60, -80, Steareth-2, -4, -10, -16, -20, -21, Sodium coceth sulfate, Sodium deceth sulfate, Sodium oleth sulfate, Sodium laureth sulfate, Sodium syreth sulfate, Sodium trideceth sulfate, Zinc coceth sulfate, 2-Dodecylbenzenesulfonic acid, 4-Dodecylbenzenesulfonic acid, Alkylbenzene sulfonates, Glucoheptonates, odium glucoheptonate, Potassium glucoheptonate, Calcium glucoheptonate, Magnesium glucoheptonate, Boron glucoheptonate, Chlorine glucoheptonate, Copper glucoheptonate, Iron glucoheptonate, Manganese glucoheptonate, Molybdenum glucoheptonate, Zinc glucoheptonate, Methanoic acid, Ethanoic acid, Propanoic acid, Butanoic acid, Pentanoic acid, Hexanoic acid, Heptanoic acid, Octanoic acid, Nonanoic acid, Decanoic acid, Undecanoic acid, Dodecanoic acid, Tridecanoic acid, Tetradecanoic acid,Pentadecanoic acid, Hexadecanoic acid, Heptadecanoic acid, Octadecanoic acid, Nonadecanoic acid, Icosanoic acid, 1,2,3-trihydroxypropane, Diethylene glycol, Alkylphenol ethoxylate, 3-oxapentane-1,5-diol, Propane-1,2,3-triol, Alkylphenol ethoxylate, Polydimethylsiloxane,1,2-Propanediol, Dimethylpolysiloxane, Fatty alcohol and butoxyethanol, Butoxyethanol, Phosphate ester surfactant, Alkyl aryl alkoxylate, Hydroxy carboxylic acids, Citric acid, Tartaric acid, Gluconic acid, Oxalic acid, Propionic acids, Phosphate ester, Ammonium sulfates, Ethoxylated surfactants, Sodium hydroxide, Anticorrosion compounds, Sequestering agents, Nonionic and Ionic surfactants, Hydroxy carbroxylates, Polyacrylates, Sugar acrylates, Aminocarboxylic acid base, Phosphate(s), Phosphonate(s), Sodium hexameta phosphate, sodium polyphosphate, Sodium tripolyphosphate, Sodium trimeta phosphate, Sodium pyrophosphates, Phosphonated aminopolycarboxylates, Amino polycarboxylates, EDTMP, DETMP, ATMP, HEDP, DTPMP, Polyether-polymethylsiloxane copolymer(s), Ethoxylated alkyl phosphate esters, C16-C28 alkanoates, Paraffin base petroleum oil, Agricultural paraffinic oil, Alkanolamide surfactants, Alkylaryl polyethoxyethanol sulfates, Alkylaryl polyoxyethylene glycol phosphate ester surfactants, Phosphate ester surfactants, Petroleum oil, Polyol fatty acid ester, Methylated seed oil, Paraffinic oil, Carbonyldiamide polyoxyalkylated glycol adduct, Carbonyl diamine, Polyoxyethylene-polyoxypropylene polymer, Methylated vegetable oil, Corn-derived surfactants, Free fatty acids, Isoproponal, Alkyl aryl polyoxyethylene glycols, Hydrogen sulfate, Aliphatic hydrocarbon oils, Polyacrylic acid salts, Polysiloxane polyether copolymer, Polyalkyleneoxide modified polydimethylsiloxane, Tall oil fatty acids, Organosilicone surfactant, Polyalkylene modified heptamethyltrisiloxane, Modified alkanoates, Poly fatty acid esters, Carbonate salts, Polysiloxane, Limonene, Allyloxypolyethyleneglycol methyl ether, Phytobland base oil, Dimethylpolysiloxane, Mineral oil, Polyether polymethylsiloxane copolymer, Nonionic carbohydrate surfactants, Polyoxythylenepolyoxyethylene-polyoxypropylene glycol, Monocarbamide dihydrogen sulfate, Antifoaming agents, Crop-based elasto polymer, Diammonium salts, and any combination thereof.

In some embodiments, the surfactant is a Polyhydroxyethyl Alkoxy Alkylene Oxide.

In some embodiments, the surfactant is a Polyoxyethylene-Polyoxyprolyene Block Co-Polymer.

In some embodiments, the surfactant is an Etherified Polyoxyethylene-Polyoxyprolyene Block Co-Polymer.

In some embodiments, the surfactant is a Modified Alkylated Polyol.

In some embodiments, the surfactant is a Modified/Methyl Capped Block Co-Polymer.

In some embodiments, the surfactant is a non-ionic polyol.

In some embodiments, the surfactant is an Alkoxylated Polyol.

In some embodiments, the surfactant is an Alkyl Polyglycoside.

In some embodiments, the surfactant is a Glucoether.

In some embodiments, the surfactant is an Alkoxylated Alcohol.

In some embodiments, the surfactant is an Alcohol Ethoxylate.

In some embodiments, the surfactant is a Polyoxytheylene.

In some embodiments, the surfactant is an anioinic blend.

In some embodiments, the one or more chemical compounds are water-soluble nutrients and the fluid is water. In some embodiments, the one or more chemical compounds are water-soluble minerals and the fluid is water. In some embodiments, the enriched fluid is water that includes one or more water soluble wetting agents. In some embodiments, the enriched fluid is water that includes one or more water-soluble surfactants. In some embodiments, the enriched fluid is water that includes one or more water soluble wetting minerals. In some embodiments, the enriched fluid is water that includes one or more water soluble nutrients.

Suitable minerals are selected from the group consisting of:

Glucoheptonates,

Sodium glucoheptonate,

Potassium glucoheptonate,

Calcium glucoheptonate,

Magnesium glucoheptonate,

Boron glucoheptonate,

Chlorine glucoheptonate,

Copper glucoheptonate,

Iron glucoheptonate,

Manganese glucoheptonate,

Molybdenum glucoheptonate,

Zinc glucoheptonate,

Potassium sulfate,

Magnesium sulfate,

Copper sulfate,

Iron sulfate,

Manganese sulfate,

Zinc sulfate,

Calcium sulfate,

Sulfur dioxide,

Urea,

Urea triazone,

Ammonium nitrate,

Ammonium phosphate,

Ammonium sulfate,

Humic acid,

Fulvic acid,

Amino acids,

Soy protein hydrolysates,

Leonardite,

Ethylenediaminetetraacetic acid,

Iron EDTA,

Iron DTPA,

Iron HEDTA,

Iron EDDHA,

Zinc EDTA,

Zinc DTPA,

Zinc HEDTA,

Zinc EDDHA,

Copper EDTA,

Copper DTPA,

Copper HEDTA,

Copper EDDHA,

Manganese EDTA,

Manganese DTPA,

Manganese HEDTA,

Manganese EDDHA,

Calcium EDTA,

Calcium DTPA,

Calcium HEDTA,

Calcium EDDHA,

Mangesium EDTA,

Magnesium DTPA,

Magnesium HEDTA,

Magnesium EDDHA,

Lignosulfonates,

Phenols,

Polyflavinoid chelates,

Citric acid,

Tartaric acid,

Gluconic acid,

Oxalic acid,

Potassium acetate,

Monoammonium phosphate,

Diammonium phosphate,

Calcium ammonium nitrate,

Ammonia,

Muriate of potash,

Molybdenum,

Zinc,

Boron,

Copper,

Calcium,

Sulfur,

Magnesium,

Manganese,

Chlorine,

Anhydrous ammonium nitrate,

Calcium nitrate,

Phosphoric acids,

Sulfuric acid,

Potassium chloride,

Potassium carbonate,

Potassium nitrate,

Calcium carbonate,

Silica fume amorphous silica,

Magnesium hydroxide,

Potassium hydroxide,

Molasses,

Corn,

Sugar cane,

Ascophyllum nodosum,

Sulfate of potash,

Charcoal,

Nitric acid,

Single superphosphate,

Merchant-grade phosphoric acid,

Triple superphosphate,

NPK compounds,

Nitro-phosphates,

Aspartate,

Threonine,

Serine,

Asparagine,

Glutamate,

Glycine,

Alanine,

Citruline,

Valine,

Cysteine,

Isoleucine,

Leucine,

Tyrosine,

Phenylalanine,

GABA,

Arginine, and

combinations thereof.

In some embodiments, the chemical compounds include a combination of at least 2 surfactants. In some embodiments, the chemical compounds include a combination of at least 3 surfactants. In some embodiments, the chemical compounds include a combination of at least 4 surfactants. In some embodiments, the chemical compounds include a combination of at least 5 surfactants.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ concepts of the various patents, applications, and publications to provide yet further embodiments.

Although the present disclosure has been described with reference to a number of illustrative embodiments, it should be understood that numerous other modifications and embodiments can be devised by those skilled in the art that will fall within the spirit and scope of the principles of this disclosure. More particularly, reasonable variations and modifications are possible in the component parts and/or arrangements of the subject combination arrangement within the scope of the foregoing disclosure, the drawings, and the appended claims without departing from the spirit of the disclosure. In addition to variations and modifications in the component parts and/or arrangements, alternative uses will also be apparent to those skilled in the art.

1. A device comprising at least one chamber, wherein the at least one chamber comprises a lid and a cannister, wherein the lid forms a fluid-tight seal with the cannister, and wherein the chamber is adapted to hold one or more tablets or pellets, wherein the one or more tablets or pellets comprise at least one surfactant or wetting agent; and wherein the chamber is in fluidic communication with first and second fluid delivery members.

2. The device of claim 1, wherein at least one of the first and second fluid delivery members include one or more seals and/or gaskets.

3. The device of claim 1, wherein at least one of the first and second fluid delivery members include one or more valves.

4. The device of claim 3, wherein the one or more valves are electrically actuated.

5. The device of claim 4, wherein the one or more electrically actuated valves are in communication with a timer.

6. The device of claim 1, wherein the chamber includes one or more baffles.

7. The device of claim 1, wherein the chamber includes a removable basket.

8. The device of claim 1, wherein the one or more tablets or pellets further comprises one or more minerals.

9. The method of claim 1, wherein at least one of the first and second fluid delivery members is fluidically coupled to a water source.

10. The method of claim 1, further comprising a manifold.

11. A device comprising at least one chamber, wherein the at least one chamber comprises a lid and a cannister, wherein the lid forms a fluid-tight seal with the cannister, and wherein the chamber is in fluidic communication with first and second fluid delivery members; and
wherein at least the chamber comprises water enriched in at least one of a surfactant or a mineral.

12. The device of claim 11, wherein the chamber further comprises one or more tablets or pellets comprising a surfactant and optionally one or more minerals.

13. The device of claim 12, wherein the chamber further comprises a basket.

14. The device of claim 11, wherein at least one of the first and second fluid delivery members include one or more seals and/or gaskets.

15. The device of claim 11, wherein at least one of the first and second fluid delivery members include one or more valves.

16. The device of claim 15, wherein the one or more valves are electrically actuated.

17. The device of claim 16, wherein the one or more electrically actuated valves are in communication with a timer.

18. The device of claim 11, wherein the chamber includes one or more baffles.
